(19) United States
(12) Patent Application Publication
(10) Pub. No.: US 2006/0112565 A1
(43) Pub. Date: Jun. 1, 2006

(54) Knife assembly having a collapsible fixed blade

(75) Inventor: Rocky Moser, Exeter, CA (US)

Correspondence Address: PITTS AND BRITTIAN P C, P O BOX 51295, KNOXVILLE, TN, 37950-1295, US

(73) Assignee: United Cutlery Corporation, Sevierville, TN (US)

(21) Appl. No.: 10/999,718

(22) Filed: Nov. 30, 2004

(51) Int. Cl. B26B 3/06

(52) U.S. Cl. 30/151; 30/162

(57) ABSTRACT

A knife assembly having a collapsible fixed blade. The collapsible fixed blade is configured such that when the knife is sheathed, the blade is retracted into the handle, and when the knife is unsheathed, the blade is extended from the handle. The knife assembly includes a knife and a sheath. The knife includes a handle and a blade. The knife further includes a locking mechanism for locking the blade in an extended orientation. The sheath is configured to receive the knife blade and engage the knife handle, and includes a lock release for disengaging the lock mechanism of the knife.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention pertains to the field of cutlery. More specifically, the present invention relates to a knife having a collapsible fixed blade, wherein when the knife sheathed, the blade is retracted into the handle, and when the knife is unsheathed, the blade is retracted into the handle.

More particularly, this invention is

2. Description of the Related Art

In the field of tools, folding tools have been known for many years. To this extent, folding knives are also well known. Typically, folding tools are provided with a handle and at least one implement. Each implement is pivotally connected at one end to one end of the handle. The handle is adapted to receive, either internally or externally, each of the implements. The implements include any one or more of a knife blade, a pair of scissors, pliers, eating utensils, screw drivers, and the like.

It is known to provide a means for locking the position of each implement in either or both of a closed and an open position. Further, it is known in the art to provide a means for assisting in the opening and/or closing of the tool. Various devices have been developed to accomplish these and other features of folding tools, and in particular, folding knives. Typical of the art are those devices disclosed in the following U.S. patents:

| Patent No. | Inventor(s) | Issue Date |
|---|---|---|
| 4,404,748 | G. Wiethoff | Sep. 20, 1983 |
| 5,060,379 | V. O. Neely | Oct. 29, 1991 |
| 5,440,814 | D. K. Hall et al. | Aug. 15, 1995 |
| 5,511,310 | G. C. Sessions et al. | Apr. 30, 1996 |
| 5,802,722 | M. Maxey et al. | Sep. 8, 1998 |
| 6,145,202 | K. J. Onion | Nov. 14, 2000 |
| 6,308,420 | R. L. Moser | Oct. 30, 2001 |
| 6,651,344 | Y. F. Cheng | Nov. 25, 2003 |
| D348,599 | K. Sakai | Jul. 12, 1994 |
| D348,818 | K. Hasegawa | Jul. 19, 1994 |
| D378,982 | L. C. Thompson | Apr. 29, 1997 |
| D473,917 | F. J. Carter III | Apr. 29, 2003 |
| D489,956 | K. Rae | May 18, 2004 |

Of these patents, the '748 patent issued to Wiethoff discloses a folding knife having a handle with a body forming a pocket into which its blade is normally retracted. The pocket is bounded by two sides of the handle traversed by respective contacts in line with a hole near an end of the blade. One cutout receives a plunger which is rigidly connected with a detent, received within the other cutout by a stem that is integral with either the plunger or the detent and traverses the hole of the blade to serve as its pivotal axle. A spring in the first cutout biases the interconnected plunger and detent into a locking position in which a projection on the detent engages in a notch of the blade to hold it in its retracted or its extended position. The biasing spring may bear directly on a confronting blade surface and co-act with one of its notches to prevent a rapid switch into the extended position.

Neely, in his '379 patent, discloses a folding knife apparatus including a blade having a tang secured to a case or housing. Wedging action between the tang and the case locks the blade open and closed. The tang includes a longitudinally extending slot. The housing includes a pin extending through the longitudinally extending slot. A spring is disposed in the slot and biases the blade against the pin to help lock the blade in place, particularly in the open position. Axial movement of the blade is required to unlock the blade from its open position in order to pivot the blade. A cam relationship exists between a portion of the tang and a portion of the case or housing to urge the blade to the closed position

The '814 patent issued to D. K. Hall et al., discloses a knife comprising a handle, a blade mounted on the handle, and a pair of side guards mounted on the handle and movable between an open position and a closed position. The pair of side guards encloses at least a portion of the blade when in the closed position. An actuating mechanism is provided for actuating the pair of guards between the open position and the closed position. The actuating mechanism includes a button movable between a forward position and a rear position and operable with the pair of side guards such that when the button is in the forward position, the pair of side guards is moved to the open position and when the button is in the rear position, the pair of side guards is moved to the closed position.

Sessions et al., in their '310 patent, disclose a folding knife including a knife blade and a handle for storing the knife blade. A pivotally biased lock bar is provided for securing the blade in an extended position. The handle is formed of two keyed sections firmly assembled together by cooperation of a lock bar biasing spring with coaxially aligned holes formed in the keyed regions of the handle sections. The lock bar biasing spring is biased outwardly against one end of a rocking type lock mechanism. When the knife blade is fully extended, the biasing spring pivots the lock mechanism about a pin, with the opposing end of the lock mechanism engaging the knife blade tang in order to lock the knife blade in the extended position.

In the '722 patent issued to Maxey et al., a one handed knife is disclosed. The '722 knife includes a handle having upper and lower handle portions. An arcuate recess extends through the upper handle portion. A blade lock release extends from the lower handle portion. A blade is pivotally connected between the upper and lower handle portions. A thumb pin extends from the blade. A tension bar having a first and second ends is slidably connected at its first end to the upper handle portion and its second end extends through the arcuate recess and is connected to the blade. When in a closed position, the blade is partially positioned between the upper and lower handle portions, the thumb pin is positioned on a portion of the blade extending from between the upper and lower handle portions, and the tension bar is in a first tensioned position at a first end of the arcuate recess. When in an open position, the blade extends from the handle, the tension bar is in a second untensioned position at a second end of the arcuate recess and the blade lock release is positioned to prevent the blade from pivoting towards the handle. The blade is caused to pivot from the first closed position into the second open position by application of a force on the thumb pin and away from the handle, the force being of a magnitude able to overcome the tension of the tension bar.

Onion, in the '202 patent, teaches a mechanism in a folding knife that urges the blade to move to an open and alternatively to a closed position. The '202 knife includes a blade member having a tang extending outwardly from the blade, a handle having at least one recessed portion, a bar pivotally connecting the tang and the handle, and a bias element engaging the blade wherein the bias element is housed within the recessed portion of the handle. The biasing element is generally a flexible elongated member which, when the blade is closed, is tensioned. When the blade is moved manually a certain distance, the biasing element serves to complete the movement of the blade, as a result of the release of tension and without the application of further outside force by the user.

Moser, in his '420 patent, teaches a folding knife which includes an elongated handle. The elongated handle includes two spaced-apart sides. An elongated blade defines a working end and a tang at the opposite end within a common plane. A pivot including a pivot axis connects the tang to the handle to permit the blade to pivot selectively into an open position at which the blade extends outwardly from the handle and into a closed position in which the blade is nested into the spacing. The blade is provided with a cam secured eccentric to the pivot axis and spaced from the plane that includes the blade. An operating spring is secured at one end to the handle and has abutting contact with the cam remote from the end in the handle thus selectively resisting the pivoting of the blade to an open position and when in an open position resisting the pivoting of the blade to a closed position.

Cheng, in his '344 patent, discloses foldable knife structure which includes a set block disposed within the handle at the pivot point of the blade. The set block defines a detent notch. A spring is situated at the end of the handle opposite the blade pivot. The distal end of the spring extends to engage the set block. When the blade is extended from or folded into the handle, the spring is biased against the circumferential edge of the set block, causing the set block to produce torsion that rotates the blade out of or into a receiving slot of the handle. The spring assists in extending and retracting the blade from the handle.

The remaining design patents each disclose the ornamental design for a folding knife.

### BRIEF SUMMARY OF THE INVENTION

The present invention is a knife assembly having a collapsible fixed blade. The collapsible fixed blade is configured such that when the knife is sheathed, the blade is retracted into the handle, and when the knife is unsheathed, the blade is extended from the handle. The knife assembly of the present invention includes generally a knife and a sheath. The knife includes generally a handle and a blade. The knife further includes a locking mechanism for locking the blade in an extended orientation. The sheath is configured to receive the knife blade and engage the knife handle, and includes a lock release for disengaging the lock mechanism of the knife.

The knife handle includes first and second handle scales. Each handle scale defines an interior face disposed toward an interior of the handle, each handle scale defining a longitudinal groove formed on the interior face. The longitudinal groove opens on the distal end of the handle scale and terminates toward the proximal end.

A primary liner is disposed on the interior face of each handle scale, each primary liner defining an interior face and an exterior face, with a secondary liner being disposed on the interior face of each primary liner. Each liner defines a proximal end and a distal end. A longitudinal slot extends from a first terminal end at a point near the proximal end and a second terminal end at a point near the distal end. The longitudinal slot coincides with the longitudinal slot defined by each handle scale. A second slot initiates at the second terminal end of the longitudinal slot and terminates at a point toward the distal end. The second slot is disposed at an acute angle with respect to the longitudinal slot.

A plurality of scale spacers is provided for spacing the handle scales and liners apart to define a blade receptor. Two scale spacers are laterally spaced apart and disposed at the proximal end of the handle, and two scale spacers are laterally spaced apart and disposed at the distal end. The blade is slidably received between the liners and within the blade receptor.

The blade is disposed between the secondary liners. The proximal end is configured to be received between the proximal end scale spacers. A pair of oppositely disposed shoulders is configured to engage the proximal end scale spacers in order to limit travel of the blade within the handle.

A guide pin receptor is provided for facilitating retraction and extension of the blade into and from within the knife handle. A guide pin is received within the guide pin receptor. The guide pin defines first and second ends configured to extend into the longitudinal slot of each of the respective liners.

A blade lock mechanism is provided for locking the blade at the extended position with respect to the handle. The blade lock mechanism is received within a blade lock mechanism slot defined by the blade. The blade lock mechanism slot defines proximal and distal ends configured to coincide with the proximal and distal ends defined by the second slot defined by the liners when the blade is in the extended position. The blade lock mechanism includes a lock pin, a slide lock, and a compression spring. The slide lock defines a lock pin opening configured to closely receive the lock pin. The compression spring is disposed between the slide lock and the proximal end of the blade lock mechanism slot such that the slide lock and lock in are biased toward the distal end of the lock mechanism slot. The lock pin defines first and second ends configured to extend through the second slot of each of the respective liners and into the longitudinal groove defined by the respective handle scale.

The sheath includes an inner sheath liner configured to releasably receive the knife blade. The sheath incorporates a locking mechanism for preventing unselected removal of the knife blade from within the inner sheath liner. The locking mechanism includes a biasing device carried by a proximal end of the inner sheath liner. A leaf spring is defined at the proximal end of each of the inner sheath liner side rails. Each leaf spring is biased toward the other leaf spring. Each leaf spring defines an inwardly extending cam configured to engage the pair of oppositely disposed shoulders defined by the blade such that as the blade is inserted into the inner sheath liner, the blade shoulders are engaged by the cams, which force the leaf springs apart. After the blade has been inserted fully into the inner sheath liner, the cams move over the blade shoulders, allowing the leaf springs to return partially toward each other, thus retaining the knife blade within the inner sheath liner.

A blade lock release mechanism is provided for releasing the blade lock mechanism in order to permit retraction of the knife blade into the handle. The blade lock release mechanism includes an elongated member disposed on external face of each sheath spacer. A distal end of each elongated member defines a notch configured to receive the first and second ends of the lock pin as the knife blade is inserted into the sheath. The notch is further configured to move the lock pin and slide lock within the blade lock mechanism slot defined by the blade after the lock pin engages the elongated member notch and the handle continues to be pushed toward the blade. The notch is configured such that the lock pin is moved into alignment with the longitudinal slot defined by the knife liners. When the lock pin is so aligned, the blade is allowed to be received within the handle.

An outer sheath cover is provided for shielding the knife when received within the sheath. The outer sheath cover includes a panel on each side of the sheath. The panels are configured to cover at least a portion of the handle, into which the blade is retracted.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of the knife assembly of the present invention illustrating the knife being received within the sheath assembly, the blade being retracted within the handle;

FIG. 2 is a perspective view of the knife assembly of the present invention illustrating the knife being withdrawn from the sheath assembly and the blade retracted from within the handle;

FIG. 3 is an exploded perspective view of the knife of the present invention showing the various components of the knife;

FIG. 4 is an exploded perspective view of the sheath assembly of the present invention showing the various components of the sheath assembly;

FIG. 5 is a top plan view of the knife assembly of the present invention, shown with the sheath cover removed from the sheath assembly and the first handle scale removed from the knife in order to show the function of the blade lock mechanism, the blade lock release mechanism and the locking mechanism of the sheath, the blade lock mechanism being shown in the locked orientation;

FIG. 6 is a top plan view of the knife assembly of the present invention, as in FIG. 5, with the blade lock release mechanism having disengaged the blade lock mechanism;

FIG. 7 is a top plan view of the knife assembly of the present invention, as in FIG. 5, with the blade fully received within the handle; and

FIG. 8 is a side elevation, in section taken along lines 8-8 of FIG. 7, of the knife assembly of the present invention.

### DETAILED DESCRIPTION OF THE INVENTION

A knife assembly having a collapsible fixed blade is disclosed. The knife assembly of the present invention includes generally a knife 10 and a sheath 114. The knife assembly of the present invention provides a knife 10 that includes a blade 76 that is retractable into and extendable from a handle 12. The knife 10 includes a blade lock mechanism 100 such that when the blade 76 is in the extended position, the blade 76 is only retractable by insertion back into the sheath 114.

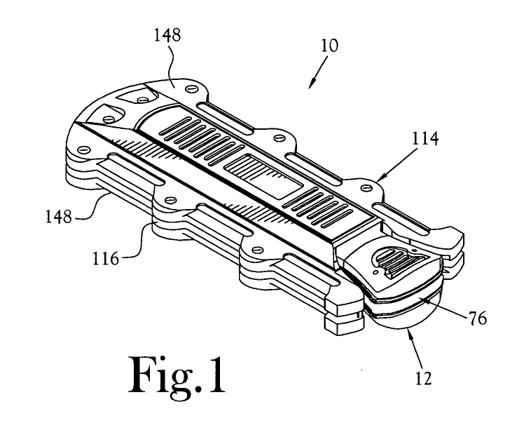

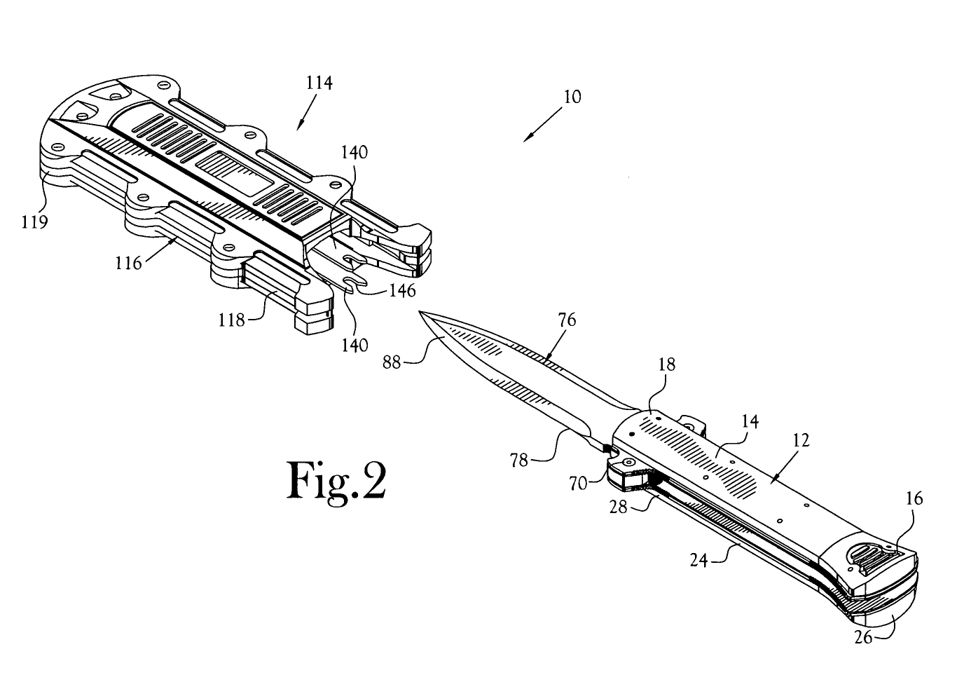

FIG. 1 is a perspective view of the knife assembly of the present invention illustrating the knife 10 received within the sheath 114, the blade 76 being retracted within the handle 12. Illustrated in FIG. 2 is a perspective view of the knife 10 having been withdrawn from the sheath 114 and the blade 76 retracted from within the handle 12.

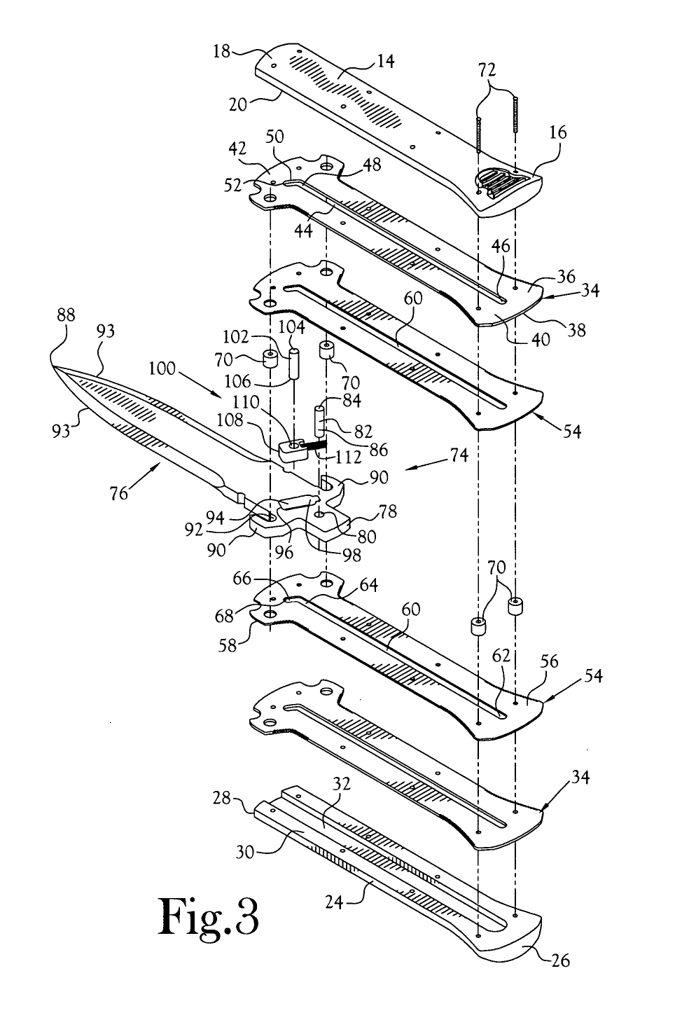

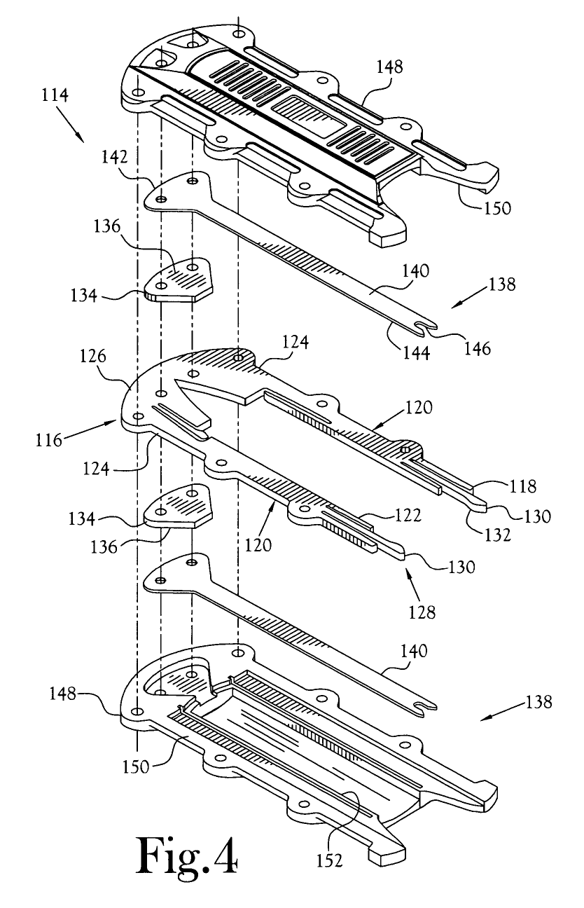

As illustrated best in FIG. 3, the knife 10 includes generally a handle 12 and a blade 76. The knife 10 is configured such that when the knife 10 is sheathed, the blade 76 is retracted into the handle 12, and when the knife 10 is unsheathed, the blade 76 is extended from the handle 12. The knife 10 further includes a locking mechanism 100 for locking the blade 76 in an extended orientation. As will be discussed in greater detail with respect to FIGS. 4-7, the sheath 114 is configured to receive the knife blade 76 and engage the knife handle 12, and includes a lock release 138 for disengaging the lock mechanism 94 of the knife 10.

The knife handle 12 includes a first handle scale 14 and a second handle scale 24. The first handle scale 14 defines a proximal end 16 and a distal end 18. The first handle scale 14 further defines an interior face 20 disposed toward an interior of the handle 12. Further, the first handle scale 14 defines a longitudinal groove 22 formed on the interior face 20 and opening on the distal end 18 of the first handle scale 14 and terminating toward the proximal end 16. Similarly, the second handle scale 24 defines a proximal end 26 and a distal end 28, an interior face 30 disposed toward an interior of the handle 12, and a longitudinal groove 32 formed on the interior face 30, opening on the distal end 28 of the second handle scale 24 and terminating toward the proximal end 26.

At least one liner 34 is disposed on the interior face 20,30 of each handle scale 14,24. In the illustrated embodiment, a primary liner 34 is disposed on the interior face 20,30 of each handle scale 14,24, each primary liner 34 defining an interior face 36 and an exterior face 38, with a secondary liner 54 being disposed on the interior face 36 of each primary liner 34.

Each primary liner 34 defines a proximal end 40 and a distal end 42. A longitudinal slot 44 extends from a first terminal end 46 at a point near the proximal end 40 and a second terminal end 48 at a point near the distal end 42. The longitudinal slot 44 coincides with the longitudinal groove 22,32 defined by each handle scale 14,24. A second slot 50 initiates at the second terminal end 48 of the longitudinal slot 44 and terminates at a point toward the primary liner distal end 42. The second slot 50 is disposed at an acute angle with respect to the longitudinal slot 44.

Similar to the primary liners 34, each of the secondary liners 54 defines a proximal end 56 and a distal end 58. A longitudinal slot 60 extends from a first terminal end 62 at a point near the proximal end 56 and a second terminal end 64 at a point near the distal end 58. The longitudinal slot 60 coincides with both the primary liner longitudinal slot 44 and the longitudinal groove 22,32 defined by each handle scale 14,24. A second slot 66 is defined by each secondary liner 54 and coincides with the primary liner second slot 50. The second slot 66 initiates at the second terminal end 64 of the longitudinal slot 60 and terminates at a point toward the distal end 58 of the secondary liner 54. The second slot 66 is disposed at an acute angle with respect to the longitudinal slot 60.

A plurality of scale spacers 70 is provided for spacing the handle scales 14,24 and liners 34,54 apart to define a blade receptor 74. In the illustrated embodiment, two scale spacers 70 are laterally spaced apart and disposed at the proximal end 16,26 of the first and second handle scales 14,24, and two scale spacers 70 are laterally spaced apart and disposed at the distal end 18,28. The handle scales 14,24 and liners 34,54 are secured to the spacers 70 using conventional fasteners 72, such as the illustrated screws.

The blade 76 is sidably received between the liners 34,54 and within the blade receptor 74. In the illustrated embodiment, the blade 76 is disposed between the secondary liners 54. The blade 76 defines a proximal end 78 and a distal end 88. The proximal end 78 is configured to be received between the proximal end scale spacers 70. A pair of oppositely disposed shoulders 90 defined at the proximal end 78 of the blade 76 is configured to engage the proximal end scale spacers 70 in order to limit travel of the blade 76 within the handle 12. Each shoulder 90 defines a recess 92 on the distal side thereof, each recess 92 being configured to receive one of the distal end scale spacers 70 to limit travel of the blade 76 when extended from the handle 12. At least one cutting edge 93 is defined on the distal side of the shoulders 90.

In order to facilitate retraction and extension of the blade 76 into and from within the knife handle 12, and further to limit movement of the blade 76 to longitudinal movement with respect to the handle 12, the proximal end 78 of the blade 76 defines a guide pin receptor 80. A guide pin 82 is received within the guide pin receptor 80. The guide pin 82 defines a first end 84 and a second end 86 configured to extend through the longitudinal slot 44,60 of each of the respective primary and secondary liners 34,54 and into the longitudinal groove 22,32 defined by the respective handle scale 14,24 (see FIG. 8).

A blade lock mechanism 100 is provided for locking the blade 76 at the extended position with respect to the handle 12. The blade lock mechanism 100 is received within a blade lock mechanism slot 94 defined by the blade 76. The blade lock mechanism slot 94 defines a proximal end 96 and a distal end 98 configured to coincide with the respective ends 48,64 and 52,68 defined by the second slot 50,66 defined by the liners 34,54 when the blade 76 is in the extended position. The blade lock mechanism 100 includes a lock pin 102, a slide lock 108, and a compression spring 112. The slide lock 108 defines a lock pin opening 110 configured to closely receive the lock pin 102. The compression spring 112 is disposed between the slide lock 108 and the proximal end 96 of the blade lock mechanism slot 94 such that the slide lock 108 and lock pin 102 are biased toward the distal end 98 of the lock mechanism slot 94. The lock pin 102 defines first and second ends 104,106 configured to extend through the second slot 50,66 of each of the respective liners 34,54 and into the longitudinal groove 22,32 defined by the respective handle scale 14,24 (see FIG. 8). To this extent, the longitudinal groove 22,32 of each handle scale 14,24 is dimensioned at least at the distal end 18,28 to receive both the guide pin 82 and the lock pin 102 when the lock pin 102 is biased to its extent toward the distal end 98 of the blade lock mechanism slot 94.

Illustrated in FIG. 4 are the various components of the sheath 114. The sheath 114 of the present invention is configured to receive the knife blade 76 and handle 12 disclosed herein. The sheath 114 includes an inner sheath liner 116 configured to releasably receive the knife blade 76. The inner sheath liner 116 generally defines a U-shaped configuration having opposing side rails 120 connected at a distal end 124 of each by an end rail 126. The side rails 120 are spaced apart to loosely receive the knife blade 76.

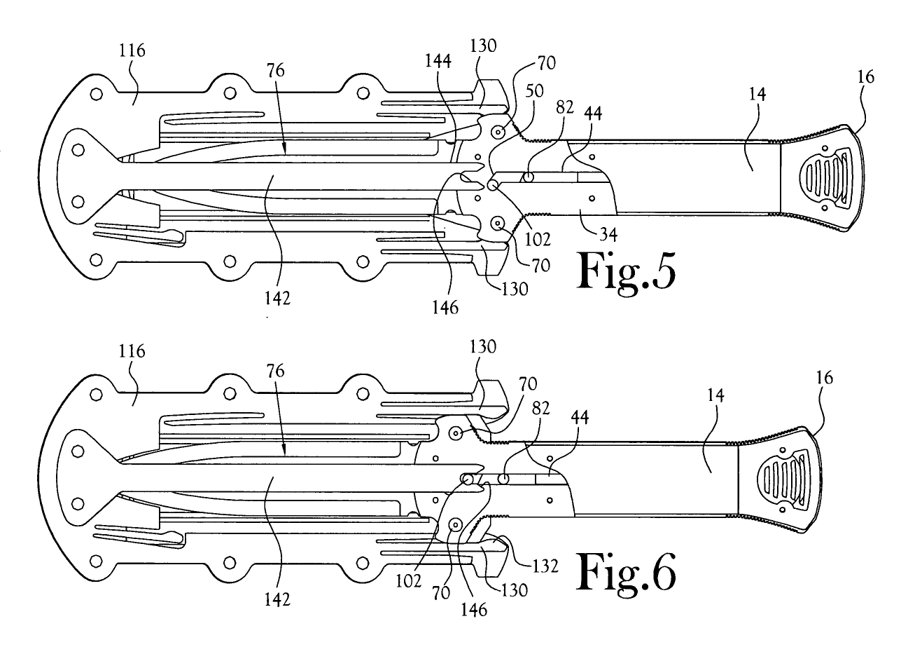

The sheath 114 incorporates a locking mechanism 128 for preventing unselected removal of the knife blade 76 from within the inner sheath liner 116. In the illustrated embodiment, the locking mechanism 128 includes a biasing device 130 carried by a proximal end 118 of the inner sheath liner 116. More specifically, in the illustrated embodiment, a leaf spring 130 is defined at the proximal end 122 of each of the inner sheath liner side rails 120. Each leaf spring 130 is biased toward the other leaf spring 130. Further, each leaf spring 130 defines an inwardly extending cam 132 configured to engage the pair of oppositely disposed shoulders 90 defined by the blade 76 such that as the blade 76 is inserted into the inner sheath liner 116, the blade shoulders 90 are engaged by the cams 132, which force the leaf springs 130 apart. This is best illustrated in FIGS. 5-7. After the blade 76 has been inserted fully into the inner sheath liner 116, the cams 132 move over the blade shoulders 90, allowing the leaf springs 130 to return partially toward each other, thus retaining the knife blade 76 within the inner sheath liner 116. While a specific locking mechanism 128 has been illustrated and described, it will be understood that other locking mechanisms 128 may be incorporated as well, without departing from the spirit of the present invention.

A spacer 134 is disposed on each side of the distal end 119 of the inner sheath liner 118. The spacers 134 and inner sheath liner 118 are configured to define a combined thickness at least equal to the thickness of the blade 76 and the knife handle liners 34,54.

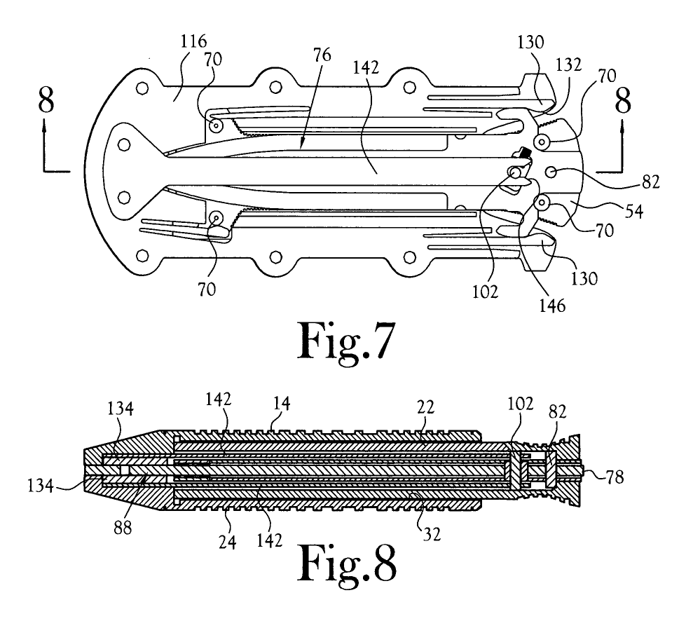

A blade lock release mechanism 138 is provided for releasing the blade lock mechanism 100 in order to permit retraction of the knife blade 76 into the handle 12. The blade lock release mechanism 138 of the illustrated embodiment includes an elongated member 40 disposed on an external face 136 of each sheath spacer 134. Each elongated member 140 is secured at a proximal end 142 to the respective spacers 134. A distal end 144 of each elongated member 140 defines a notch 146 configured to receive the first and second ends 104,106 of the lock pin 102 after the knife blade 76 has been substantially inserted into the sheath 114, as illustrated in FIG. 5. As illustrated in FIG. 6, the notch 146 is further configured to move the lock pin 102 and slide lock 108 within the blade lock mechanism slot 94 defined by the blade 76 after the lock pin 102 engages the elongated member notch 146 and the handle 12 continues to be pushed toward the blade 76. The notch 146 is configured such that the lock pin 102 is moved into alignment with the longitudinal slot 44,60 defined by the knife liners 34,54. When the lock pin 102 is so aligned, the blade 76 is allowed to be received within the handle 12, as best illustrated in FIG. 7. To this extent, the elongated members 140 and the longitudinal grooves 22,32 defined by the handle scales 14,24 are cooperatively configured such that each elongated member 140 is receivable within the respective handle scale longitudinal groove 22,32.

An outer sheath cover 148 is provided for shielding the knife blade 76 when received within the sheath 114. In the illustrated embodiment, the outer sheath cover 148 includes a panel on each side of the sheath 114. The panels 148 are configured to cover at least a portion of the handle 12, into which the blade 76 is retracted. To this extent, a portion of the proximal end of the handle 12 remains exposed to facilitate gripping in order to remove the handle 12 from the sheath 114. Each panel 148 defines an interior face 150 which defines a recess 152 configured to receive the respective handle scale 14,24. While a specific outer sheath cover 148 has been illustrated and described, it will be understood that other outer sheath covers 148 may be incorporated as well, without departing from the spirit of the present invention.

FIG. 8 illustrates the knife assembly 10 of the present invention wherein the knife blade 76 and handle 12 are received within the sheath 114. In order to retract the knife handle 12 and extend the blade 76 from within the handle 12, the proximal end of the handle 12 is grasped and pulled away from the sheath 114. As the handle 12 is being pulled from the sheath 114, the blade 76 remains within the inner sheath liner 116 and is held in place via the sheath locking mechanism 128. As the handle 12 is pulled, the lock pin 102 and guide pin 82 travel within the longitudinal groove 22,32 defined by each handle scale 14,24, as well as the longitudinal slot 44,60 defined by each knife liner 34,54. When the lock pin 102 reaches the second terminal end 48,64 of the liner longitudinal slots 44,60, the compression spring 112 biases the slide lock 108 and lock pin 102 toward the distal end 98 of the blade lock mechanism slot 94, thereby locking the blade 76 in the extended position with respect to the handle 12, prior to being removed from the sheath inner liner 116. As the handle 12 is continued to be pulled, the sheath locking mechanism 128 is disengaged to release the blade 76 from the sheath 114. In the illustrated embodiment, the knife shoulders 90 engage and separate the leaf spring cams 132, thereby spreading the leaf springs 130 while the shoulders 90 engage the leaf spring cams 132. When the knife shoulders 90 have been moved past the leaf spring cams 132, the knife blade 76 is disengaged and removable from within the sheath 114.

In order to insert the knife blade 76 into the sheath 114, the removal process is essentially reversed. The knife blade 76 is inserted into the sheath inner liner 116 until the knife shoulders 90 engage the leaf spring cams 132. The knife blade 76 is continued to be pushed into the sheath 114 to engage the sheath locking mechanism 128. The lock pin 102 is then engaged by the elongated members 140 in order to disengage the blade lock mechanism 100, thereby allowing retraction of the blade 76 into the handle 12, and insertion of the handle 12 into the sheath 114.

From the foregoing description, it will be recognized by those skilled in the art that a knife assembly having a collapsible fixed blade has been provided. The collapsible fixed blade is configured such that when the knife is sheathed, the blade is retracted into the handle, and when the knife is unsheathed, the blade is extended from within the handle. The knife includes a blade locking mechanism for locking the blade in an extended orientation. The sheath includes a locking mechanism for locking the blade in the sheath when sheathed.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, I claim:

1. A knife assembly comprising:
a knife including a handle and a blade, said blade being slidably received within said handle, said blade being extendable from said handle to an extended position and retractable within said handle to a retracted position, said knife further including a blade lock mechanism for locking said blade with respect to said handle when said blade is in said extended position; and
a sheath assembly adapted to releasably receive at least a portion of said knife, said sheath assembly including a blade lock release mechanism for disengaging said blade lock mechanism such that said blade is allowed to move toward said retracted position when said blade is at least partially received within said sheath assembly.

2. The knife assembly of claim 1 wherein said blade lock mechanism is received within a blade lock mechanism slot defined by said blade, said blade lock mechanism slot defining a proximal end and a distal end, and wherein said blade lock mechanism includes:
a lock pin defining a first end and a second end, said first and second ends being configured to extend into at least one longitudinal groove defined by said handle when disposed proximate said proximal end of said blade lock mechanism slot;
a slide lock defining a lock pin opening configured to closely receive said lock pin, said slide lock being disposed within said blade lock mechanism slot; and
a compression spring disposed within said blade lock mechanism slot between said proximal end thereof and said slide lock, whereby said slide lock and said lock pin are biased toward said distal end of said lock mechanism slot;
whereby when said blade is at said extended position, said lock pin is disposed proximate said distal end of said blade lock mechanism slot, thereby preventing said blade from being moved toward said retracted position, said blade being movable toward said retracted position only upon movement of said lock pin toward said proximal end of said blade lock mechanism slot.

3. The knife assembly of claim 2 wherein said blade lock release mechanism includes at least one lock pin engagement member carried by said sheath assembly, said lock pin engagement member being configured to engage said lock pin upon insertion of at least a portion of said blade within said sheath assembly, said lock pin engagement member further being configured to urge said lock pin toward said proximal end of said lock mechanism slot as said knife is pushed toward said sheath assembly, thereby releasing said blade lock mechanism and allowing said handle to be pushed over said blade in order to dispose said blade in said retracted position.

4. The knife assembly of claim 3 wherein said lock pin engagement member is an elongated member defining a proximal end and a distal end, said elongated member proximal end being carried by a distal end of said sheath assembly, said distal end of each elongated member defining a notch configured to receive either of said lock pin first and second ends as said blade is inserted into said sheath assembly, said notch being further configured to move said lock pin and said slide lock within said blade lock mechanism slot after said lock pin engages said notch and as said knife is pushed toward said sheath assembly.

5. The knife assembly of claim 4 wherein said elongated member is configured to be received within said at least one longitudinal groove defined by said handle.

6. The knife assembly of claim 1 wherein said handle defines a proximal end and a distal end, and wherein said handle includes:
a first handle scale defining a proximal end, a distal end, and an interior face, said first handle defining a longitudinal groove formed on said interior face, opening on said distal end of said first handle scale and terminating proximate said proximal end of said first handle scale;
a second handle scale defining a proximal end, a distal end, and an interior face, said second handle defining a longitudinal groove formed on said interior face, opening on said distal end of said second handle scale and terminating proximate said proximal end of said second handle scale;
a plurality of spacers disposed between said first handle scale and said second handle scale, whereby a blade receptor is defined between said first handle scale and said second handle scale, wherein said blade is received within said blade receptor; and
a plurality of fasteners for securing said first handle scale and said second handle scale to said plurality of spacers.

7. The knife assembly of claim 6 wherein said handle further comprises a plurality of liners disposed between said first handle scale and said second handle scale, said plurality of liners including at least a first liner disposed on said interior face of said first handle scale and a second liner disposed on said interior face of said second handle scale, each of said plurality of liners defining an interior face and an exterior face, and wherein said plurality of spacers is disposed between said first liner and said second liner.

8. The knife assembly of claim 6 wherein said plurality of spacers includes two proximal end spacers laterally spaced apart and disposed at said proximal end of said handle, and two distal end spacers laterally spaced apart and disposed at said distal end of said handle, wherein said blade defines a proximal end and a distal end, said blade proximal end being configured to be received between said proximal end spacers, said blade defining a pair of oppositely disposed shoulders configured to engage said proximal end spacers to limit travel of said blade toward said handle proximal end when at said retracted position and to engage said distal end spacers to limit travel of said blade toward said handle distal end when at said extended position.

9. The knife assembly of claim 8 further comprising a locking mechanism including a biasing device carried by said sheath assembly, said biasing device adapted to engage at least one of said oppositely disposed shoulders of said blade when said blade is at least partially received within said sheath assembly, whereby said blade is prevented from unselected removal from within said sheath assembly.

10. A knife assembly comprising:
a knife including:
a handle;
a blade sidably received within said handle, said blade being extendable from said handle to an extended position and retractable within said handle to a retracted position; and
a blade lock mechanism for locking said blade with respect to said handle when said blade is in said extended position, said blade lock mechanism being received within a blade lock mechanism slot defined by said blade, said blade lock mechanism slot defining a proximal end and a distal end, said blade lock mechanism including:
a lock pin defining a first end and a second end, said first and second ends being configured to extend into at least one longitudinal groove defined by said handle when disposed proximate said proximal end of said blade lock mechanism slot;
a slide lock defining a lock pin opening configured to closely receive said lock pin, said slide lock being disposed within said blade lock mechanism slot; and
a compression spring disposed within said blade lock mechanism slot between said proximal end thereof and said slide lock, whereby said slide lock and said lock pin are biased toward said distal end of said lock mechanism slot;
whereby when said blade is at said extended position, said lock pin is disposed proximate said distal end of said blade lock mechanism slot, thereby preventing said blade from being moved toward said retracted position, said blade being movable toward said retracted position only upon movement of said lock pin toward said proximal end of said blade lock mechanism slot;
a sheath assembly adapted to releasably receive at least a portion of said knife, said sheath assembly including a blade lock release mechanism for disengaging said blade lock mechanism such that said blade is allowed to move toward said retracted position when said blade is at least partially received within said sheath assembly, said blade lock release mechanism including at least one lock pin engagement member configured to engage said lock pin upon insertion of at least a portion of said blade within said sheath assembly, said lock pin engagement member further being configured to urge said lock pin toward said proximal end of said lock mechanism slot as said knife is pushed toward said sheath assembly, thereby releasing said blade lock mechanism and allowing said handle to be pushed over said blade in order to dispose said blade in said retracted position; and
a locking mechanism provided for preventing unselected removal of said blade from within said sheath assembly.

11. The knife assembly of claim 10 wherein said lock pin engagement member is an elongated member defining a proximal end and a distal end, said elongated member proximal end being carried by a distal end of said sheath assembly, said distal end of each elongated member defining a notch configured to receive either of said lock pin first and second ends as said blade is inserted into said sheath assembly, said notch being further configured to move said lock pin and said slide lock within said blade lock mechanism slot after said lock pin engages said notch and as said knife is pushed toward said sheath assembly.

12. The knife assembly of claim 11 wherein said elongated member is configured to be received within said at least one longitudinal groove defined by said handle.

13. The knife assembly of claim 10 wherein said handle defines a proximal end and a distal end, and wherein said handle includes:
a first handle scale defining a proximal end, a distal end, and an interior face, said first handle defining a first of said at least one longitudinal groove on said interior face, opening on said distal end of said first handle scale and terminating proximate said proximal end of said first handle scale;
a second handle scale defining a proximal end, a distal end, and an interior face, said second handle defining a second of said at least one longitudinal groove on said interior face, opening on said distal end of said second handle scale and terminating proximate said proximal end of said second handle scale;
a plurality of spacers disposed between said first handle scale and said second handle scale, whereby a blade receptor is defined between said first handle scale and said second handle scale, wherein said blade is received within said blade receptor; and
a plurality of fasteners for securing said first handle scale and said second handle scale to said plurality of spacers.

14. The knife assembly of claim 13 wherein said handle further comprises a plurality of liners disposed between said first handle scale and said second handle scale, said plurality of liners including at least a first liner disposed on said interior face of said first handle scale and a second liner disposed on said interior face of said second handle scale, each of said plurality of liners defining an interior face and an exterior face, and wherein said plurality of spacers is disposed between said first liner and said second liner.

15. The knife of claim 14 wherein said plurality of liners defines a proximal end, a distal end, a longitudinal slot, and an angular slot, said longitudinal slot extending from a first terminal end proximate said proximal end and a second terminal end proximate said distal end, said longitudinal slot coinciding with said at least one longitudinal groove defined by said handle, said second slot extending from said longitudinal slot second terminal end and terminating at a point toward said distal end, said second slot being disposed at an acute angle with respect to said longitudinal slot, said second slot coinciding with said blade lock mechanism slot defined by said blade when said blade is in said extended position.

16. The knife of claim 15 further comprising a guide pin, and wherein said blade defines a guide pin receptor for closely receiving said guide pin, said guide pin defining a first end and a second end configured to extend through said longitudinal slot defined by each of said plurality of liners and into said at least one longitudinal groove defined by said handle, whereby retraction and extension of said blade into and from within said handle is limited to longitudinal movement with respect to said handle.

17. The knife assembly of claim 14 wherein said plurality of spacers includes two proximal end spacers laterally spaced apart and disposed at said proximal end of said handle, and two distal end spacers laterally spaced apart and disposed at said distal end of said handle, wherein said blade defines a proximal end and a distal end, said blade proximal end being configured to be received between said proximal end spacers, said blade defining a pair of oppositely disposed shoulders configured to engage said proximal end spacers to limit travel of said blade toward said handle proximal end when at said retracted position and to engage said distal end spacers to limit travel of said blade toward said handle distal end when at said extended position.

18. The knife assembly of claim 17 wherein said locking mechanism includes a biasing device carried by said sheath assembly, said biasing device adapted to engage at least one of said oppositely disposed shoulders of said blade when said blade is at least partially received within said sheath assembly, whereby said blade is prevented from unselected removal from within said sheath assembly.

18. The knife assembly of claim 10 wherein said sheath assembly includes an inner sheath liner configured to releasably receive said blade, said inner sheath liner defining opposing side rails and an end rail, each of said side rails defining a proximal end and a distal end, said end rail being connected between said distal end of each of said side rails.

19. The knife assembly of claim 18 wherein said locking mechanism includes a biasing device carried by said proximal end of at least one of said inner sheath liner side rails, said biasing device being configured to releasably engage said blade when received within said sheath assembly.

20. A knife assembly comprising:
a knife including:
a handle defining a proximal end and a distal end, said handle including:
a first handle scale defining a proximal end, a distal end, and an interior face, said first handle defining a longitudinal groove on said interior face, opening on said distal end of said first handle scale and terminating proximate said proximal end of said first handle scale;
a second handle scale defining a proximal end, a distal end, and an interior face, said second handle defining a longitudinal groove on said interior face, opening on said distal end of said second handle scale and terminating proximate said proximal end of said second handle scale;
a plurality of spacers disposed between said first handle scale and said second handle scale, whereby a blade receptor is defined between said first handle scale and said second handle scale, wherein said blade is received within said blade receptor; and
a plurality of fasteners for securing said first handle scale and said second handle scale to said plurality of spacers;
a blade slidably received within said handle, said blade being extendable from said handle to an extended position and retractable within said handle to a retracted position; and
a blade lock mechanism for locking said blade with respect to said handle when said blade is in said extended position, said blade lock mechanism being received within a blade lock mechanism slot defined by said blade, said blade lock mechanism slot defining a proximal end and a distal end, said blade lock mechanism including:
a lock pin defining a first end configured to extend into said first handle scale longitudinal groove and a second end configured to extend into said second handle scale longitudinal groove, when said lock pin is disposed proximate said proximal end of said blade lock mechanism slot;
a slide lock defining a lock pin opening configured to closely receive said lock pin, said slide lock being disposed within said blade lock mechanism slot; and
a compression spring disposed within said blade lock mechanism slot between said proximal end thereof and said slide lock, whereby said slide lock and said lock pin are biased toward said distal end of said lock mechanism slot;
whereby when said blade is at said extended position, said lock pin is disposed proximate said distal end of said blade lock mechanism slot, thereby preventing said blade from being moved toward said retracted position, said blade being movable toward said retracted position only upon movement of said lock pin toward said proximal end of said blade lock mechanism slot;
a sheath assembly adapted to releasably receive at least a portion of said knife, said sheath assembly including:
an inner sheath liner configured to releasably receive said blade, said inner sheath liner defining opposing side rails and an end rail, each of said side rails defining a proximal end and a distal end, said end rail being connected between said distal end of each of said side rails; and
a blade lock release mechanism for disengaging said blade lock mechanism such that said blade is allowed to move toward said retracted position when said blade is at least partially received within said sheath assembly, said blade lock release mechanism including at least one lock pin engagement member configured to engage said lock pin upon insertion of at least a portion of said blade within said sheath assembly, said lock pin engagement member further being configured to urge said lock pin toward said proximal end of said lock mechanism slot as said knife is pushed toward said sheath assembly, thereby releasing said blade lock mechanism and allowing said handle to be pushed over said blade in order to dispose said blade in said retracted position; and
a locking mechanism provided for preventing unselected removal of said blade from within said sheath assembly, said locking mechanism including a biasing device carried by said proximal end of at least one of said inner sheath liner side rails, said biasing device being configured to releasably engage said blade when received within said sheath assembly.

21. The knife assembly of claim 20 wherein said lock pin engagement member is an elongated member defining a proximal end and a distal end, said elongated member proximal end being carried by said inner sheath liner, said distal end of each elongated member defining a notch configured to receive either of said lock pin first and second ends as said blade is inserted into said sheath assembly, said notch being further configured to move said lock pin and said slide lock within said blade lock mechanism slot after said lock pin engages said notch and as said knife is pushed toward said sheath assembly.

22. The knife assembly of claim 21 wherein said blade lock release mechanism includes a first said lock pin engagement member carried by an upper face of said inner sheath liner and a second said lock pin engagement member carried by a lower face of said inner sheath liner, whereby said first lock pin engagement member is configured to engage said lock pin first end and said second lock pin engagement member is configured to engage said lock pin second end.

23. The knife assembly of claim 22 wherein said first lock pin engagement member is configured to be received within said first handle scale longitudinal groove and said second lock pin engagement member is configured to be received within said second handle scale longitudinal groove.

24. The knife assembly of claim 20 wherein said handle further comprises a plurality of liners disposed between said first handle scale and said second handle scale, said plurality of liners including at least a first liner disposed on said interior face of said first handle scale and a second liner disposed on said interior face of said second handle scale, each of said plurality of liners defining an interior face and an exterior face, and wherein said plurality of spacers is disposed between said first liner and said second liner.

25. The knife of claim 24 wherein said plurality of liners defines a proximal end, a distal end, a longitudinal slot, and an angular slot, said longitudinal slot extending from a first terminal end proximate said proximal end and a second terminal end proximate said distal end, said longitudinal slot coinciding with said first handle scale longitudinal groove and said second handle scale longitudinal groove, said second slot extending from said longitudinal slot second terminal end and terminating at a point toward said distal end, said second slot being disposed at an acute angle with respect to said longitudinal slot, said second slot coinciding with said blade lock mechanism slot defined by said blade when said blade is in said extended position.

26. The knife of claim 25 further comprising a guide pin, and wherein said blade defines a guide pin receptor for closely receiving said guide pin, said guide pin defining a first end and a second end configured to extend through said longitudinal slot defined by each of said plurality of liners and into said at least one longitudinal groove defined by said handle, whereby retraction and extension of said blade into and from within said handle is limited to longitudinal movement with respect to said handle.

27. The knife assembly of claim 20 wherein said plurality of spacers includes two proximal end spacers laterally spaced apart and disposed at said proximal end of said handle, and two distal end spacers laterally spaced apart and disposed at said distal end of said handle, wherein said blade defines a proximal end and a distal end, said blade proximal end being configured to be received between said proximal end spacers, said blade defining a pair of oppositely disposed shoulders configured to engage said proximal end spacers to limit travel of said blade toward said handle proximal end when at said retracted position and to engage said distal end spacers to limit travel of said blade toward said handle distal end when at said extended position.

28. The knife assembly of claim 27 wherein said biasing device is configured to engage at least one of said oppositely disposed shoulders of said blade when said blade is at least partially received within said sheath assembly, whereby said blade is prevented from unselected removal from within said sheath assembly.

29. The knife assembly of claim 28 wherein a first said inner sheath liner opposing side rail defines a first said biasing device, and a second said inner sheath liner opposing side rail defines a second said biasing device, said first biasing device being configured to engage a first said blade shoulder and said second biasing device being configured to engage a second said blade shoulder.
